(19) United States
(12) Patent Application Publication
(10) Pub. No.: US 2025/0392445 A1
(43) Pub. Date: Dec. 25, 2025

(54) SYMMETRIC ENCRYPTION FOR PRIVATE SMART CONTRACTS AMONG MULTIPLE PARTIES IN A PRIVATE PEER-TO-PEER NETWORK

(71) Applicant: Experian Information Solutions, Inc., Costa Mesa, CA (US)

(72) Inventors: Vijay Mehta, Newport Beach, CA (US); Alexander Phan, Aliso Viejo, CA (US)

(21) Appl. No.: 19/261,723

(22) Filed: Jul. 7, 2025

Related U.S. Application Data
(63) Continuation of application No. 18/595,850, filed on Mar. 5, 2024, now Pat. No. 12,381,712.
Application No. 18/595,850 is a continuation of application No. 18/295,694, filed on Apr. 4, 2023, now Pat. No. 11,962,681.
Application No. 18/295,694 is a continuation of application No. 16/941,142, filed on Jul. 28, 2020, now Pat. No. 11,652,607.
Application No. 16/941,142 is a continuation of application No. 16/022,354, filed on Jun. 28, 2018, now Pat. No. 10,735,183.
(60) Provisional application No. 62/527,579, filed on Jun. 30, 2017.

(51) Int. Cl. H04L 9/06; H04L 9/08; H04L 9/16; H04L 67/1074

(52) U.S. Cl. CPC H04L 9/0637; H04L 9/0822; H04L 9/0891; H04L 9/0894; H04L 9/16; H04L 67/1074

(57) ABSTRACT

Features for providing a secure method of symmetric encryption for private smart contacts among multiple parties in a private peer-to-peer network. The features include a master key representing a unique blockchain ledger. The master key may be shared among multiple participants in a private peer-to-peer network. Sharing of the master key may include communicating the master key in an encrypted message (e.g., email) using public key infrastructure (PKI). In some implementations, more complex distribution features may be includes such as quantum entanglement. The features support instantiation of a smart contract using a specific master key. The request may be submitted as an entry to the ledger with appropriate metadata and/or payload information for identifying and processing the request.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57.

### BACKGROUND

Distributed ledgers have enabled new systems for networks of users to create a trusted network for tracking and verifying transactions. Bitcoin is one example of a distributed ledger system for managing a cryptocurrency.

Not all transactions lend themselves to a publicly reviewable ledger system, like Bitcoin. In some instances, a private peer-to-peer network may be established to protect the information stored in the ledger. In such implementations, a limited number of trusted entities participate to provide similar features to the public ledgers. Each entity may record ledger entries and validate entries to confirm entries as authentic. The ledger entries may be associated with a multi-step process. The collection of entries related to one instance of the process may be referred to as a smart contract. However, an entity in the peer-to-peer network may wish to protect the details of their transaction (in total or certain steps) while simultaneous reaping the benefit of the trusted network.

### SUMMARY

The present disclosure describes systems and methods for providing a secure method of symmetric encryption for private smart contacts among multiple parties in a private peer-to-peer network.

The systems, methods, and devices of the disclosure each have several innovative aspects, no single one of which is solely responsible for the desirable attributes disclosed herein. In one innovative aspect system for secure distributed electronic ledgering is provided. The system includes a master encryption key store storing a plurality of master encryption keys associated with respective client devices; a distributed electronic ledger storing a record generated by a client device included in the client devices, where the record includes: a first portion including unencrypted metadata. The record includes second portion including an internal encryption key encrypted with a master encryption key. The records includes store also includes a third portion including a request for a service, the request encrypted with the internal encryption key. The system also includes a computer-readable memory storing executable instructions and one or more computer processors in communication with the computer-readable memory, where the one or more computer processors are configured to execute the executable instructions to at least: determine that the record has been added to the distributed electronic ledger based at least in part on the unencrypted metadata, retrieve the master encryption key from the master encryption key store based at least in part on the unencrypted metadata, decrypt the second portion of the record using the master encryption key to obtain the internal encryption key, decrypt the third portion of the record to obtain the request, transmit the request to a service selected based at least in part on the request, receive a response from the service, insert at least a portion of the response into the third portion of the record, encrypt the third portion of the record using an encryption key, and store the record in the distributed electronic ledger. Other embodiments of this aspect include corresponding computer systems, apparatus, and computer programs recorded on one or more computer storage devices, each configured to perform the actions of the methods.

In one innovative aspect a system for secure distributed electronic ledgering is provided. The system includes a computer-readable memory storing executable instructions and one or more computer processors in communication with the computer-readable memory, where the one or more computer processors are configured to execute the executable instructions. Upon execution the instructions cause the one or more computer processors to at least: determine that a record has been added to a distributed electronic ledger based at least in part on unencrypted metadata included in a first portion of the record, where the record further includes: (a) a second portion including an internal encryption key encrypted with a master encryption key, and (b) a third portion including a request for a service, the request encrypted with the internal encryption key; retrieve the master encryption key from a data store based at least in part on the unencrypted metadata; decrypt the second portion of the record using the master encryption key to obtain the internal encryption key; decrypt the third portion of the record to obtain the request; transmit the request to a service selected based at least in part on the request; receive a response from the service; insert at least a portion of the response into the third portion of the record; encrypt the third portion of the record using an encryption key; and store the record in the distributed electronic ledger. Other embodiments of this aspect include corresponding computer systems, apparatus, and computer programs recorded on one or more computer storage devices, each configured to perform the actions of the methods.

Implementations of the systems described may include one or more of the following features. The encryption key used for encrypting the third portion may include the internal encryption key. The one or more computer processors may be further configured to execute the executable instructions to at least: generate a revised internal encryption key in response to obtaining the internal encryption key; and encrypt the second portion of the record using the revised internal encryption key, and where the encryption key used for encrypting the third portion includes the revised internal encryption key. The distributed electronic ledger may be further configured to transmit the record via a network, such as a private peer-to-peer network, to a remote distributed electronic ledger hosted by one of the client devices. The one or more computer processors may be further configured to execute the executable instructions to at least: identify a set of records stored in the distributed electronic ledger including a value in respective unencrypted metadata portions; for individual records in the set of records, retrieve the master encryption key from the master encryption key store based at least in part on unencrypted metadata of a first portion of an individual record, decrypt a second portion of the individual record using the master encryption key to obtain an individual internal encryption key, decrypt a third portion of the individual record using the individual internal encryption key to obtain individual record payload data, and validate the individual record payload data. The one or more computer processors may be further configured to execute the executable instructions to at least: initiate a transfer of resources from a first source identified by the individual record payload data to a destination associated with the service. The innovative features described may include or be implemented by hardware, a method or process, or computer software on a computer-accessible medium.

### BRIEF DESCRIPTION OF THE DRAWINGS

FIG. 1 is a block diagram illustrating an example private peer-to-peer network between three entities.

FIG. 2 is a process diagram illustrating an ordered process for providing a credit inquiry response using a distributed ledger.

FIG. 3 is a block diagram showing example components of a distributed ledger computing system.

### DETAILED DESCRIPTION

A master key, representing a unique blockchain ledger, may be shared among multiple participants in a private peer-to-peer network. Sharing of the master key may include communicating the master key in an encrypted message (e.g., email) using public key infrastructure (PKI). In some implementations, more complex distribution features may be includes such as quantum entanglement. A smart contract may be instantiated when requesting a service or data using a specific master key. The request may be submitted as an entry to the ledger with appropriate metadata and/or payload information for identifying and processing the request. On creation, the smart contract may include a randomly generated internal key that may remain private for the life of the smart contract. The internal key may be used to encrypt confidential data within the smart contract, and then the master key may, in turn, be used to encrypt the internal key. This process ensures that the smart contract can only be read and modified by participants of the smart contract holding the proper keys. Each participant has access to the shared master key. With exception of non-confidential transactional metadata, the smart contract remains opaque to other non-participating peers of the private blockchain network.

### Master Key and Internal Key

Both the master key and internal key are a form of symmetric encryption; there is no public component as it occurs in PKI encryption.

Master keys may be shared between organizations participating in the private peer-to-peer network. Each master key may represent a blockchain ledger. Each transaction may use one and only one master key. The master key may be used to encrypt the internal key of the smart contract, after the internal key has encrypted the confidential elements of the blockchain contract (e.g., ledger record). The master key, along with metadata for the ledger record, may serve as a signature of each participating organization.

A master key preferably is associated with a unique identifier. Participant systems may use the unique identifier to optimize key identification and retrieval from each organization's key stores. Transmission of master keys outside of a peer's information security boundaries may be minimized or restricted to protect the integrity of the keys. Life-cycle management of the master key can be tied to business contracts and may be non-permanent. For example, a master key may be generated for transactions occurring within a period of time (e.g., monthly, quarterly, annually). A master key may represent a shared blockchain ledger that can be validated by peers who possess the master key. The master key may represent the shared blockchain ledger because without the appropriate master key, the block cannot be assembled into a chain and verified. Once decrypted using the associated master key, the block can be read and verified.

Internal keys are never exposed outside of a smart contract. Opening a smart contract may require the appropriate master key and identifying metadata that uniquely identifies the entity that can open the smart contract. This metadata could be the hash-hash of the public key that represents a blockchain account, or wallet, of the entity that is authorized to open the smart contract. Opening a smart contract with the appropriate master key may first decrypt the internal key. Once the internal key is decrypted, the internal key may be used to decrypt one or more confidential components of the smart contract.

Closing the smart contract is also performed using a master key. The master key may be used to encrypt the internal key after the internal key encrypts the smart contract data. The internal key may or may not be regenerated for improved security after a successful opening. The actual nature of the internal key may be completely opaque to all elements external to the smart contract. Providing the master key to close the contract can protect the internal key and also can be used as a signature of the transaction for “lite” verification/validation.

### Private Peer-to-Peer Network

Unlike current implementations of digital currency, the private smart contracts, or blockchain blocks, described herein may be processed in a private peer-to-peer network. The network may include consensus servers, maintained by each peer, and coupled via secured communication links such as a virtual private network or tunneled network. The consensus servers may validate smart contracts between two or more peers. Validation may include confirming that the entries are authentic (e.g., entered by the party claiming to have authored the entry) and non-repudiated (e.g., not reversed or otherwise indicated as an error).

Each organization that participates in the private distributed, blockchain network may implement a consensus server. Each peer's consensus server may only have access to master keys for blockchain ledgers that the peer has a right to access. The right may be assigned by a central authority or through communications between entities. One or more master keys may be required to open, or decrypt the contract, for validation. For smart contracts associated with master keys that are not contained or associated with the organization, may be unreadable and thus cannot be validated by the organization. Such records may be dropped or excluded from validation by the unaffiliated organization. For example, some unencrypted metadata may be provided such as a token or identifier to retrieve the master key. Other metadata may be included for identification of a party or a transaction or a transaction type. For instance, in a contract between three or more parties, each party may want to know who updated a record and in what way. The metadata or a portion thereof may include an encrypted token that can only be decrypted by the token's owner. The encrypted metadata (e.g., private metadata) may not be used for blockchain verification. The private metadata may be used for identifying or confirming transactions. Other parties may the private metadata as base64-encoded data without understanding the true contents.

Because these blocks are secured using master keys, these blocks remain opaque to unauthorized parties without the appropriate master key(s).

A smart blockchain contract may include one or more of the following elements:
An embedded, non-retrievable, encrypted private key;
A confidential request for the execution of a credit-reporting service;
A confidential credit report, or payload, that fulfills the request;
Confidential metadata that describes the transaction; or.
Non-confidential metadata used for routing, delivery, and fulfillment.

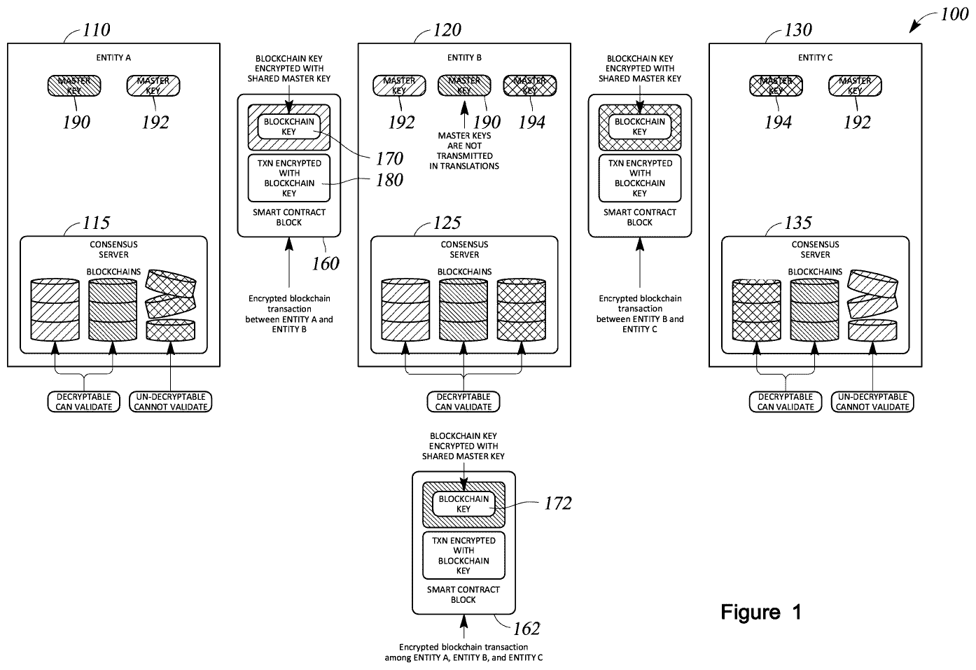

FIG. 1 is a block diagram illustrating an example private peer-to-peer network between three entities. The three entities shown in the private peer-to-peer network include Entity A 110, Entity B 120, and Entity C 130. Each entity may include its own instance of a consensus server (e.g., 115, 125, and 135, respectively). However, the information that can be validated may be limited to the records in the blockchains that relate to the entity. In this way, each entity can replicate records across the peer-to-peer network but retain privacy for individual records. Although not shown, Entity A 110, Entity B 120, and Entity C 130 may be in data communication via one or more of a wired or wireless network which may be public or private. In the case of a public network, the connection between the entities may be secured such as by using one or more of a virtual private network, tunneling, encryption, or other means to secure connections between the entities and data transmitted thereby.

FIG. 1 illustrates aspects of a system 100 for secure distributed electronic ledgering. The system 100 may include a master encryption key store storing a plurality of master encryption keys associated with respective client devices. The system 100 may include a distributed electronic ledger (e.g., blockchains) storing one or more records generated by the client device. A record may include a first portion including unencrypted metadata. The record may include a second portion including an internal encryption key (“blockchain key”) encrypted with a master encryption key. The record may include a third portion including a request for a service, the request encrypted with the internal encryption key.

The system 100 may include a device such as a server or other electronic communication device. The electronic communication device may include or be coupled with a computer-readable memory storing executable instructions. One or more computer processors (e.g., of the device) may be in communication with the computer-readable memory. The one or more computer processors may be configured to execute the executable instructions to determine the record has been added to the distributed electronic ledger based at least in part on the unencrypted metadata, retrieve the master encryption key from the master encryption key store based at least in part on the unencrypted metadata, decrypt the second portion of the record using the master encryption key to obtain the internal encryption key, decrypt the third portion of the record to obtain the request, transmit the request to a service selected based at least in part on the request, receive a response from the service, insert at least a portion of the response into the third portion of the record, encrypt the third portion of the record using an encryption key, and store the record in the distributed electronic ledger.

The encryption key used for encrypting the third portion may include the internal encryption key. In some implementations, the internal encryption key may be a one-time-use key and, once used for decrypting, be discarded. In such implementations, the one or more computer processors may be further configured to execute the executable instructions to generate a revised internal encryption key in response to obtaining the internal encryption key and encrypt the second portion of the record using the revised internal encryption key. In such implementations, the encryption key used for encrypting the third portion may include the revised internal encryption key.

The distributed electronic ledger may be configured to transmit the record via a network to a remote distributed electronic ledger hosted by one of the client devices. This ensures that other trusted entities receive the records at least for replicated storage and, when authorized, remote validation. The network may include a private peer-to-peer network.

The one or more computer processors may be configured to execute the executable instructions to identify a set of records stored in the distributed electronic ledger including a value in respective unencrypted metadata portions. For individual records in the set of records, the processors may execute instructions to retrieve the master encryption key from the master encryption key store based at least in part on unencrypted metadata of a first portion of an individual record, decrypt a second portion of the individual record using the master encryption key to obtain an individual internal encryption key, decrypt a third portion of the individual record using the individual internal encryption key to obtain individual record payload data, and validate the individual record payload data. Validation may be dynamically assessed based on the smart contract. For example, a contract for a specified model can return a score while another model may return one thousand or more attributes (each of which may be requested separately). In such instances, each contract may include a validation code (e.g., a regular expression that tests the range of values). Validation may be similar to validating credit card transactions, where each party gets a chance to review transactions before reconciling the accounts. Unlike credit transactions though, each party gets to build the blockchains for independent real-time verification, regardless of when transaction is completed. In some implementations, real-time account reconciliation may be provided. The reconciliation may include guards or limits on the number of transactions or total cost associated with transactions.

In some implementations, the one or more computer processors may be further configured to execute the executable instructions to initiate a transfer of resources from a first source identified by the individual record payload data to a destination associated with the service.

### Example Method of Contract Creation

The method of creating a smart contract 160 may be implemented by a computing device such as a consensus server and/or access device used to submit contract information to the consensus server. Entity A 110 may instantiate a smart contract for a service or data request with Entity B 120. The internal key 170 (“blockchain key”) may be randomly generated.

Entity A 110 may create and stores a service request. The blockchain address that represents Entity A's account may be added to the confidential request. The account information may be used to reconcile payment for the requested service. Metadata for the ledger entry may be updated.

Entity A may close the smart contract 160 by using a master key shared with other entities involved in processing the request. Closure may include automatically encrypting all or specific confidential components of the smart contract with the internal key 170. In this example, Entity A encrypts the internal key (“blockchain key”) with the master key 190 shared with Entity B 120.

Entity A may submit the private blockchain contract to the network or service endpoint for fulfillment. Submitting the contract 160 may include recording the record on the distributed ledger. The consensus server 115 of Entity A 110 may include a replication process to disseminate records to other peers on the network.

Having created the contract 160, the ledger may be monitored by an entity (e.g., Entity B). The monitoring may include identifying entries in the ledger with specific metadata or record type. Once a record is identified by an entity that can provide the requested service or data, the entity may initiate processing to fulfill the request identified by the contract 160.

### Example Method of Contract Fulfillment

A method of fulfilling a smart contract may be implemented by a computing device such as a consensus server and/or access device used to submit contract information to the consensus server. Continuing from the example contract creation method discussed above, the consensus server 125 of Entity B 120 may receive the smart blockchain contract 160 and, based at least in part on metadata or record type for the contract 160, identify the contract 160 as a request for a service or data provided by Entity B 120.

Metadata included in the contract 160, such as a UUID of the master key 190, may be used to find the appropriate master key (e.g., the master key 190). If the master key is identified, then the contract 160 can be fulfilled by Entity B 120. The master key 190 may be retrieved from a data store or secured key store (not shown). Entity B 120 may use the master key 190 to decrypt the internal key 170 for opening the smart contract 160. The internal key 170 may then be used to decrypt the confidential components 180 of the smart contract 160. In some implementations, a new internal key may be randomly regenerated after the successful decryption of the smart contract data. Once the contract data is decrypted, Entity B may continue processing the contract 160 to extract the request information to fulfill the request.

Entity B 120 may store one or more results of the service request in the smart contract 160. One example of a service request is a request for credit information about a user. In such implementations, the request may include information identifying the user for which credit information is being requested. Another example of a service is generating a numeric or qualitative score. For example, a service provider may implement thousands of models that accept input values and generate numeric score or qualitative attributes for the provided input values. In some implementations, the smart contract 160 may embed a model. For example, a user may create the contract 160 by sending the appropriate factors to a server or appliance of the service provider. The contract 160 may execute immediately and store the requested score/attribute/information in the contract 160. It can immediately be sent for peer verification. Service providers and customers may be interested in using blockchain technologies to identify and prevent transactional behaviors. For example, “loan-stacking” is a transactional behavior where a user intentionally or unintentionally exceeds a predetermined credit-to-income ratio threshold by applying for and receiving credit in a short amount of time. The current delay in information about credit applications can cause this stacking. By using blockchain smart contracts, all participants can have current transaction history (e.g., credit application history) in real-time for a user to ensure behavior consistent with the predetermined criteria.

Entity B 120 may add metadata, including, for example, a blockchain address for an account that may receive payment.

Entity B 120 may close the smart contract with the master key 190. To close the smart contract 160, the internal key 170 may first be used to encrypt all or specified confidential components 180 of the smart contract 160. The master key 189 may then be used to encrypt the internal key 170.

Entity B 129 may transmit the blockchain representing the smart contact to the peer-to-peer network for external validation by consensus servers associated with other entities (e.g., Entity A). Entity B 129 can also immediately validate the smart contract 160 on a server it controls.

### Example Method of Contract Validation

Entity A 110 and Entity B 120 may manage internal consensus servers 115 and 125, respectively. A consensus server may be “internal” to an entity if it is controlled by the entity. The consensus servers 115 and 125 for Entity A 110 and Entity B 120 may each have access to the master key 190 that represents the relationship between Entity A 110 and Entity B 120. Validation can be initiated after the master key 190 is used to decrypt the internal key 170 embedded in the smart contract 160. Validation may be performed by both parties. Reconciliation of accounts can be performed at a predetermined time such as: post-transaction, real-time, batch schedule, etc. In some implementations, more than two parties may coordinate satisfaction of a contract. In such implementations, each participant may have access to a master key for the contract. For example, all three entities shown in FIG. 1 have access to master key 192 which may be used for protecting an internal key 172 for a smart contract 162 associated with all three entities.

Validation may include one or more mathematical processes (e.g., a Merkle root, proof-of-work, nonces, algos, and degrees of difficulty, etc.) to confirm the integrity of the blockchain similar to those used to verify Bitcoin transactions. These processes can be resource intensive as the number of parties and records increase.

One non-limiting advantage of the master key features described is to decrease the resources needed to validate records. For example, opening and closing with the correct master key and required metadata provides a digital signature. The ledger is maintained in a private peer-to-peer network, which also provides some level of trust and protection (e.g., from distributed denial of service attacks) for the ledger. In light of these safeguards, the verification may bypass the resource intensive mathematical approach, which is designed to protect against shortcomings of an open network and total lack of trust. Validation can be done by verifying the integrity of the contract and some protected metadata such as decrypting an internal token that was encrypted with one's public key. The approach described is also one way for two participants in a multi-party contract to exchange private data and still share a core contract with all parties.

### Discussion of Certain Features and Non-Limiting Advantages

Symmetric encryption in the form of shared master keys and internal keys, embedded in smart contracts, enables multiple parties to participate in confidential transactions using blockchain technology.

Shared master keys each represent non-permanent blockchain ledgers between two or more parties.

Master keys can be recreated on a predictable basis, which defines may a lifecycle for the corresponding blockchain. Recreation of the master key can be done to improve security, limit the blockchain length, or reduce the resources needed to process and validate smart contracts.

The smart contract can only be opened, closed and processed (read, modified) using the appropriate master key. Without the appropriate master key, the smart contract (or at least its confidential components) may remain encrypted and opaque to non-participating peers and outside-network entities.

The smart contract can expose a limited set of functions to retrieve and store data. The smart contract never exposes the internal key. It is a program that has blockchain components (headers, use of PKI to represent accounts/wallets/addresses, etc.) but also has the “smart” parts: the private encryption key, public metadata, encrypted data and encrypted metadata. Some possible functions that may be used to access the smart contact are shown in Table 1 below. The functions in Table 1 enable the smart contract to be implemented as a “black box” requiring little if any knowledge of the implementation on the part of the participating parties.

TABLE 1

| Example Functions | Descriptions |
|---|---|
| boolean | Opens a new smart contract using the |
| open(master_key, | specified master key and metadata. May |
| metadata); | return true if the open was successful and |
| | false if open failed. |
| request | Obtains the request included in the smart |
| getRequest( ); | contract. May require successful opening |
| | prior to obtaining the request. |
| void | Includes the specified request in the smart |
| saveRequest | contract. The request may include a request |
| (request); | for a service or information. |
| data getData( ); | Retrieve the data included in the smart |
| | contract. The data may represent a result or |
| | response to the request. |
| void saveData(data); | Save data in the smart contract. The data |
| | may represent a result or response to |
| | the request. |
| boolean | Confirms whether data is included in the |
| checkData( ); | contract. Returns true if included and false |
| | if not included. |
| boolean isValid( ); | Confirms whether data included in the |
| | contract is valid. Validity may be assessed |
| | based on who added data to the smart |
| | contract as well as what data was added to |
| | the smart contract. Returns true if valid and |
| | false if invalid. |
| boolean | Closes the smart contract using the |
| close(master_key, | specified master key and metadata. May |
| metadata); | return true if the close was successful and |
| | false if close failed. |

The internal key can be seamlessly auto-regenerated after successfully being decrypted by the master key and after being used by the smart contract to decrypt the confidential components.

Consensus servers may be included. The consensus servers may be included to provide the appropriate master keys in order to validate and build the blockchains.

Validation can be done with appropriate blockchain algorithms (such as Ethereum or Bitcoin's proof-of-work) or short-circuited; the act of closing a smart contract with the appropriate master key and metadata can be agreed as a legally binding, fully auditable action since only parties involved in the smart contract have access to the matching master key and supportive metadata. Hence, validation can be computationally very fast. Short-circuiting may be included where participants rely on the private network and master/internal key features to protect the ledger rather than expending resources to perform resource intensive record validation, as discussed herein.

These private smart contracts can be used to request services with or without return of data.

### Example Use Case—User Credit Inquiry

The private peer-to-peer network features described may be used to provide secure transactions in a variety of systems. One example use case is a private peer-to-peer network for entities to submit credit inquiries such as part of processing a loan application. In such examples, Entity A from FIG. 1 above may be a bank or other entity deciding whether to extend credit. Entity B may be a credit reporting agency with access to user data for generating credit scores or reports.

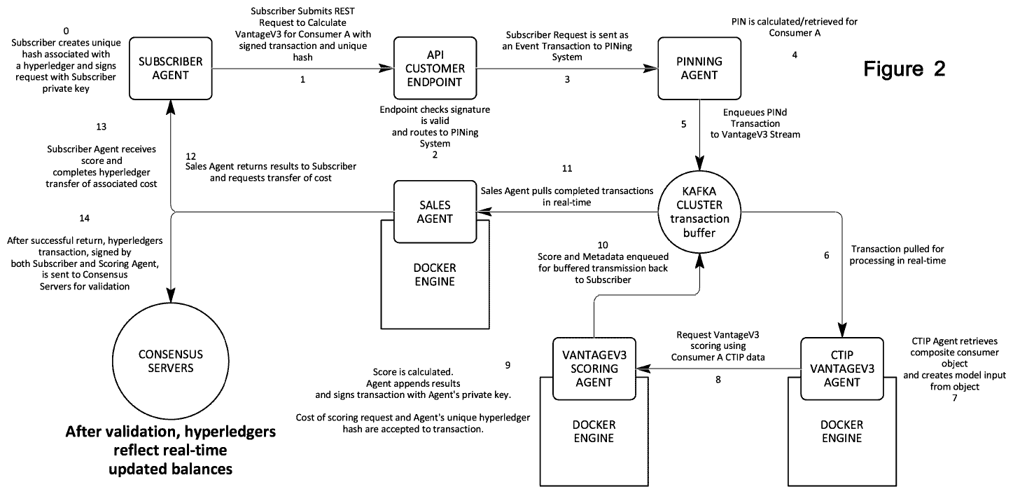

FIG. 2 is a process diagram illustrating an ordered process (steps 0-14) for providing a credit inquiry response using a distributed ledger. FIG. 2 shows various exemplary systems that may participate in the use case such as a subscriber (e.g., customer of the service), subscriber agent (e.g., a system or device that that represents the subscriber in a transaction), hyperledger (e.g., a private distributed ledger data store similar to a Bitcoin Wallet), docker engine (e.g., a container that executes a single program, such as the agents); a message queue that stores intermediate data (e.g., Kafka message queues); consensus servers (e.g., machines that can mathematically verify that the signed transaction is valid. Consensus servers can be operated by both service providers and service subscribers for independent verification), other agents (e.g., systems configured to perform a single set of related tasks such as generating models, retrieving or processing inputs for the model, processing/formatting output from the model).

In the example shown in FIG. 2, a subscriber integrates with a service provider's distributed applications platform. The subscriber may create a hyperledger account with associated private and public keys. The subscriber may initiate a request to calculate a model value for a specific user through an agent process. The subscriber agent may execute the request using one of the public/private key combinations associated with the subscriber account. The request may include information about the user and metadata concerning the transaction.

The service provider's application programming interface (API) endpoint may perform a security check using the metadata. The security check may include confirming unencrypted metadata is present or that valid unencrypted metadata values are provided such that the values may be used to identify a party. Examples of such metatdata include subscriber identifier, IP address, ledger address, account identifier, etc. In some implementations, the security check may include comparing one or more values to a “whitelist” of approved values. If a value included in a contract appears on the whitelist, the contract may be permitted. The security check may be an operational security feature on the request. Additional validation of the transaction may be performed later in the processing. The user information is used to generate a lookup key for the service provider data that represents the user. In this example, the user/consumer information is provided by the requesting agent and used to find the data in the service provider's database. However, the user information may be indirectly provided, inferred, or obtained such as based on values included in the smart contract.

The entire transaction may then be buffered in a message queue. The queue may be processed in real-time as a stream. Each transaction may be “pulled” by a listening agent, such as the customer transaction information profile (CTIP) agent shown in FIG. 2. The CTIP agent may retrieve the user data based at least in part on the lookup key. The CTIP agent may process the user data to generate input data for another system such as the scoring agent. As discussed, the model may be stored as part of the smart contact. In the example shown, the Scoring Agent executes and stores the specific model (e.g., VantageV3), provides a reference to a service provider's hyperledger account using one of several associated private/public keys, transaction cost and associated metadata. The model result is then stored in a Subscriber-specific topic in the transaction buffer. A sales agent, which may be listening to that specific message queue topic on behalf of the subscriber, may “pull” transaction results in real-time and delivers it back to the subscriber agent to complete the transfer of cost. The subscriber agent may receive the transaction result and authorizes the transfer of cost to the service provider's hyperledger, referenced by the hyperledger address associated with the smart contract. The entire transaction may be represented as a blockchain that is then validated by internal and external consensus servers. The results provide real-time visibility on the transaction processing and allocation of resources for the transaction (e.g., billing).

The hyperledger may be implemented using alternate technologies dissimilar from a Bitcoin Wallet, or similar digital currency container. The implementation of the hyperledger should provide an electronic account ledger that a service provider or a service subscriber can visualize in real-time and can both validate independently. The visualization may include real-time monitoring of the ledger to identify requests and responses thereto. The visualization may include a user interface to present monitoring information in aggregate (e.g., for a particular party, request type, user(s), etc.) or for a specific request. The interface may include indicators as to whether the smart contract or elements included therein are valid. The hyperledger can be incremented up and down, even to negative values if no digital currency is used. Transfers of actual resources (e.g., money) can occur at pre-agreed intervals, including real-time.

### Example System Implementation and Architecture

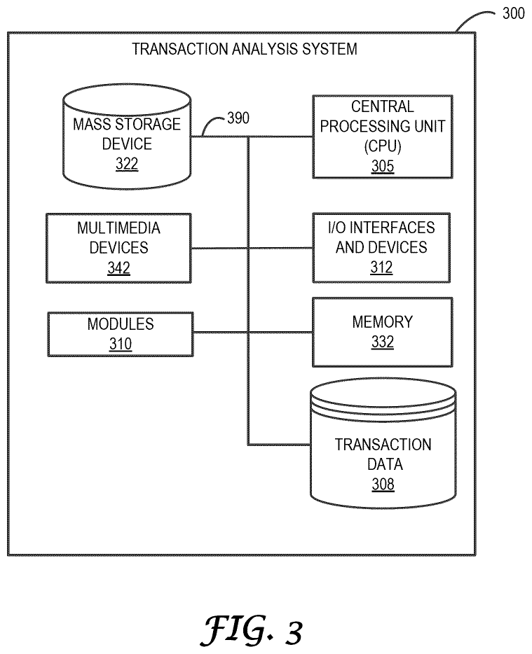

FIG. 3 is a block diagram showing example components of a distributed ledger computing system 300. The computing system 300 includes, for example, a personal computer that is IBM, Macintosh, or Linux/Unix compatible or a server or workstation. In one embodiment, the computing system 300 comprises a server, a laptop computer, a smart phone, a personal digital assistant, a kiosk, or a media player, for example. In one embodiment, the exemplary computing system 300 includes one or more central processing unit (“CPU”) 305, which may each include a conventional or proprietary microprocessor. The computing system 300 further includes one or more memory 332, such as random access memory (“RAM”) for temporary storage of information, one or more read only memory (“ROM”) for permanent storage of information, and one or more mass storage device 322, such as a hard drive, diskette, solid state drive, or optical media storage device. Typically, the components of the computing system 300 are connected using a standard based bus system 390. In different embodiments, the standard based bus system 390 could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of computing system 300 may be combined into fewer components and modules or further separated into additional components and modules.

The computing system 300 is generally controlled and coordinated by operating system software, such as Windows XP, Windows Vista, Windows 7, Windows 8, Windows Server, Unix, Linux, SunOS, Solaris, iOS, Blackberry OS, or other compatible operating systems. In Macintosh systems, the operating system may be any available operating system, such as MAC OS X. In other embodiments, the computing system 300 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 300 may include one or more commonly available input/output (I/O) devices and interfaces 312, such as a keyboard, mouse, touchpad, and printer. In one embodiment, the I/O devices and interfaces 312 include one or more display devices, such as a monitor, that allows the visual presentation of data to a user. More particularly, a display device provides for the presentation of GUIs, application software data, and multimedia presentations, for example. The computing system 300 may also include one or more multimedia devices 342, such as speakers, video cards, graphics accelerators, and microphones, for example.

In the embodiment of FIG. 3, the I/O devices and interfaces 312 provide a communication interface to various external devices. In the embodiment of FIG. 3, the computing system 300 is electronically coupled to one or more networks, which comprise one or more of a LAN, WAN, and/or the Internet, for example, via a wired, wireless, or combination of wired and wireless, communication link. The networks communicate with various computing devices and/or other electronic devices via wired or wireless communication links, such as the credit Bureau data source and financial information data sources.

In some embodiments, information may be provided to the computing system 300 over a network from one or more data sources. The data sources may include one or more internal and/or external data sources that provide transaction data, such as credit issuers (e.g., financial institutions that issue credit cards), transaction processors (e.g., entities that process credit card swipes at points of sale), and/or transaction aggregators. The data sources may include internal and external data sources which store, for example, credit bureau data (for example, credit bureau data from File OneSM) and/or other user data. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer-readable medium, such as a compact disc, digital video disc, flash drive, or any other tangible medium. Such software code may be stored, partially or fully, on a memory device of the executing computing device, such as the computing system 300, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In the example of FIG. 3, the modules 310 may be configured for execution by the CPU 305 to perform any or all of the process discussed above with reference to FIG. 1 or 2. Depending on the embodiment, certain processes, or in the processes, or groups of processes discussed herein may be performed by multiple devices, such as multiple computing system similar to computing system 300. For example, depending on the embodiment, certain of the processes described herein may be performed by a computing system that obtains and stores the ledger, while other processes are performed by systems or devices that access the ledger for validation and yet others are performed by systems or devices that monitor, read, or write to the ledger or process requests submitted thereby.

### Additional Embodiments

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, the described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

As used herein a “data store” may be embodied in hard disk drives, solid state memories and/or any other type of non-transitory computer-readable storage medium accessible to or by a device such as an access device, server, or other computing device described. A data store may also or alternatively be distributed or partitioned across multiple local and/or remote storage devices as is known in the art without departing from the scope of the present disclosure. In yet other embodiments, a data store may include or be embodied in a data storage web service.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some implementations, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein a “user interface” (also referred to as an interactive user interface, a graphical user interface or a UI) may refer to a network based interface including data fields and/or other controls for receiving input signals or providing electronic information and/or for providing information to the user in response to any received input signals. A UI may be implemented in whole or in part using technologies such as hyper-text mark-up language (HTML), ADOBE® FLASH®, JAVA®, MICROSOFT®.NET®, web services, and rich site summary (RSS). In some implementations, a UI may be included in a stand-alone client (for example, thick client, fat client) configured to communicate (e.g., send or receive data) in accordance with one or more of the aspects described.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the computing system and/or any other suitable computing device. The methods may be executed on the computing devices in response to execution of software instructions or other executable code read from a tangible computer-readable medium. A tangible computer-readable medium is a data storage device that can store data that is readable by a computer system. Examples of computer-readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

1. (canceled)

2. A system for secure distributed electronic ledgering, the system comprising:
a distributed electronic ledger storing a set of records, wherein at least one record in the set of records includes a request for a service;
a computer-readable memory storing executable instructions; and
one or more computer processors in communication with the computer-readable memory, wherein the one or more computer processors are configured to execute a smart contract, causing the processor to:
receive, from the distributed electronic ledger over a peer-to-peer network, the smart contract, the smart contract includes metadata associated with a master encryption key, an encrypted internal encryption key, and an encrypted service request;
retrieve the master encryption key using the metadata;
decrypt the encrypted internal encryption key with the master encryption key to open the smart contract;
decrypt the encrypted service request using the internal encryption key;
fulfill the service request and store fulfillment data associated with fulfillment of the service request in the smart contract;
close the smart contract by encrypting the at least a portion of the fulfillment data with the internal encryption key; and
transmit, to the peer-to-peer network, the closed smart contract.

3. The system of claim 2, wherein the one or more computer processors are further configured to identify the smart contract as the service request.

4. The system of claim 2, wherein the one or more computer processors are further configured to generate a new internal encryption key.

4. The system of claim 4, wherein the one or more computer processors are further configured to use the new encryption key to close the smart contract.

6. The system of claim 2, wherein the at least one record is generated by a client device of a plurality of client devices.

7. The system of claim 2, wherein the master encryption key is stored in a master encryption key store storing a plurality of master encryption keys associated with respective client devices.

8. The system of claim 2, wherein the service request includes at least one of: a request for a credit reporting service, a request for a credit report, or a request for information related to a transaction.

9. A computer-implemented method for secure distributed electronic ledgering, the computer-implemented method comprising:
receiving, from a distributed electronic ledger over a peer-to-peer network, a smart contract, the distributed electronic ledger storing a set of records, wherein at least one record in the set of records includes a request for a service, data, or payload, wherein the smart contract includes metadata associated with a master encryption key, an encrypted internal encryption key, and an encrypted request;
retrieving the master encryption key using the metadata;
decrypting the encrypted internal encryption key with the master encryption key to open the smart contract;
decrypting the encrypted request using the internal encryption key;
fulfilling the request and storing fulfillment data in the smart contract;
closing the smart contract by encrypting the at least a portion of the fulfillment data with the internal encryption key; and
transmitting, to the peer-to-peer network, the closed smart contract.

10. The computer-implemented method of claim 9 further comprising identifying the smart contract as the request.

11. The computer-implemented method of claim 9 further comprising generating a new internal encryption key.

12. The computer-implemented method of claim 11 further comprising using the new encryption key to close the smart contract.

13. The computer-implemented method of claim 9, wherein the at least one record is generated by a client device of a plurality of client devices.

14. The computer-implemented method of claim 9, wherein the master encryption key is stored in a master encryption key store storing a plurality of master encryption keys associated with respective client devices.

15. The computer-implemented method of claim 9, wherein the request is selected from the group consisting of a request for a credit reporting service, a request for a credit report, a request for information related to a transaction, and combinations thereof.

16. A non-transitory computer storage medium storing computer-executable instructions that, when executed by a processor configured to execute a smart contract, cause the processor to perform the following operations:
receive, from a distributed electronic ledger over a peer-to-peer network, the smart contract, the distributed electronic ledger storing a set of records, wherein at least one record in the set of records includes a request for a service, data, or payload, wherein the smart contract includes metadata associated with a master encryption key, an encrypted internal encryption key, and an encrypted request;
retrieve the master encryption key using the metadata;
decrypt the encrypted internal encryption key with the master encryption key to open the smart contract;
decrypt the encrypted request using the internal encryption key;
fulfill the request and store fulfillment data in the smart contract;
close the smart contract by encrypting the at least a portion of the fulfillment data with the internal encryption key; and
transmit, to the peer-to-peer network, the closed smart contract.

17. The non-transitory computer storage medium of claim 16, wherein the operations further comprise identifying the smart contract as the request.

18. The non-transitory computer storage medium of claim 16, wherein the operations further comprise generating a new internal encryption key.

18. The non-transitory computer storage medium of claim 18, wherein the operations further comprise using the new encryption key to close the smart contract.

20. The non-transitory computer storage medium of claim 16, wherein the master encryption key is stored in a master encryption key store storing a plurality of master encryption keys associated with respective client devices.

21. The non-transitory computer storage medium of claim 16, wherein the request includes a request for a credit reporting service, a request for a credit report, or a request for information related to a transaction.
